(19) United States
(12) Patent Application Publication
(10) Pub. No.: US 2005/0281266 A1
(43) Pub. Date: Dec. 22, 2005

(54) Human readable and writable addressing method in a home network protocol

(75) Inventors: Kwangsoon Choi, Incheon-si (KR); Kwangmo Jung, Gyeonggi-do (KR); Woong Chul Choi, Gyeonggi-do (KR)

Correspondence Address: GREENBLUM & BERNSTEIN, P.L.C., 1950 ROLAND CLARKE PLACE, RESTON, VA, 20191, US

(73) Assignee: Korea Electronics Technology Institute, Pyeongtaek-si (KR)

(21) Appl. No.: 11/024,782

(22) Filed: Dec. 30, 2004

(30) Foreign Application Priority Data
Jun. 22, 2004 (KR) 10-2004-0046785

(51) Int. Cl. H04L 12/66

(52) U.S. Cl. 370/392

(57) ABSTRACT

A human readable and writable addressing method in a home network is disclosed. A disclosed method comprises inputting a URL type, inputting the address of a gateway server, and inputting a device indicator.

### BACKGROUND OF THE INVENTION

1. Field of the Invention

The present disclosure relates generally to a human readable and writable addressing method in a home network protocol and, more particularly, to an addressing method employing a new URL structure for a home network.

2. Background of the Related Art

In recent years, high speed networks such as xDSL spread out rapidly. In line with this trend, many companies are launching various kinds of electric home appliances which have a network communication function and for accessing the internet.

A home network is defined as a network configured to communicate inter-electric home appliances, or to communicate the home appliances to information terminals in a house such as PDAs, PCs or notebooks. However, to implement the home network, various network are necessary, it is not easy for users to understand the concept of the protocols and to configure the network.

Typically, subscribers obtain unique addresses from ISPs (internet service providers) to identify themselves on the internet. In most cases, however, the unique address of the subscribers can be changed without a notice to the subscribers even in using the internet service. In short, a floating address is allocated to the subscribers. In the case where the floating address is assigned to the subscribers, the subscribers are denied accessing the home network from the outside of the house.

In other words, the internet is where the computers are coupled with various networks, and transfers and receives data with predetermined protocols. Thus, to transmit and receive the data, every computer connected to the internet is required to have a unique address to distinguish each other. If the floating addresses are respectively assigned to the subscribers, the intrinsic address of the computer is changed every time the subscriber accesses the internet. Therefore, the device having the changed address cannot be found on the outside network.

The unique address on the internet is represented by either a numeric method or an alphanumeric method. The address defined by the numeric method is referred to as an IP (internet protocol) address by which network devices on the internet readily find each other. The alphanumeric address, so called Domain, has been introduced for users' own convenience. Every network device on the internet has to have either a numeric address or an alphanumeric address. Both the numeric and alphanumeric addresses should be a unique address throughout the world.

A desired domain name is inputted to user's web browser. The web browser then asks an IP address corresponding to the domain name to a DNS (Domain Name Server). The DNS starts searching the database of the DNS to response the request of the user. If a matched IP address is found, the IP address is sent to user's web browser. By using the IP address, the user starts communicating with the web server having a domain name corresponding to the IP address.

A domain name system in the DNS server translates the domain name into the corresponding IP address. For communication on the internet by employing the domain name, the IP address matched with the target domain name should be registered in at least one certificated DNS server.

Under the condition of the DNS server, if the IP addresses of home network devises are frequently changed, the DNS servers will suffer from converting the domain names of the home network devices to the corresponding IP addresses. Thus, users who know only the domain names have difficulty in accessing to the home network devices from the outside of home.

Plural network devices on the internet are not allowed to share the one single IP address without predetermined devices, resulting in retarding the spread of the home network.

Moreover, to build the home network, the users need to conceive network configuration knowledge, and set various network service. However, because most internet users are unfamiliar with the network related knowledge, the users typically suffer from understanding the concept of the protocol, and setting the service of the server.

A predetermined address allocates the unique address to each network device within a home network. However, because each home networks adopt different addressing methods, the designated unique addresses of the network devices in the different home networks lack inter-compatibility. Therefore, a home gateway system is used to transfer the data signal from one home network to the other home network. The home gateway system converts the data signal to the signal used in the target network.

FIG. 1 illustrates a hypertext transfer protocol (hereinafter referred to as “HTTP”) according to the prior art.

Referring to FIG. 1, HTTP 1 represents a protocol. The domain name 2 shows the logical address corresponding to the IP address of a server. A resource identifier 3 represents the file name.

The HTTP needs the unique address to transfer or receive the data through the internet. Because the floating IP address as a unique address changes frequently, users find difficulty in accessing to the target server which has the floating IP address.

U.S. Pat. No. 6,584,096, Allan et al., discloses a method and apparatus for connecting a home network to the Internet using the ports or sockets of the home gateway to multiplex the data flow.

U.S. Pat. No. 6,151,624, Teare et al., discloses mechanisms for associating metadata with network resources, and for locating the network resources in a language-independent manner. According to this invention, the network resources can be located merely by providing the name of the network resource in any natural language that is convenient for the client.

U.S. Pat. No. 6,006,272, Aravamudan et al., discloses a method for translating non internet unique addresses of a home network device to an internet unique address for internet communication through a router.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a hypertext transfer protocol (hereinafter referred to as “HTTP”) according to the prior art; and

FIG. 2 is a block-diagram comparing the prior method with the present invention.

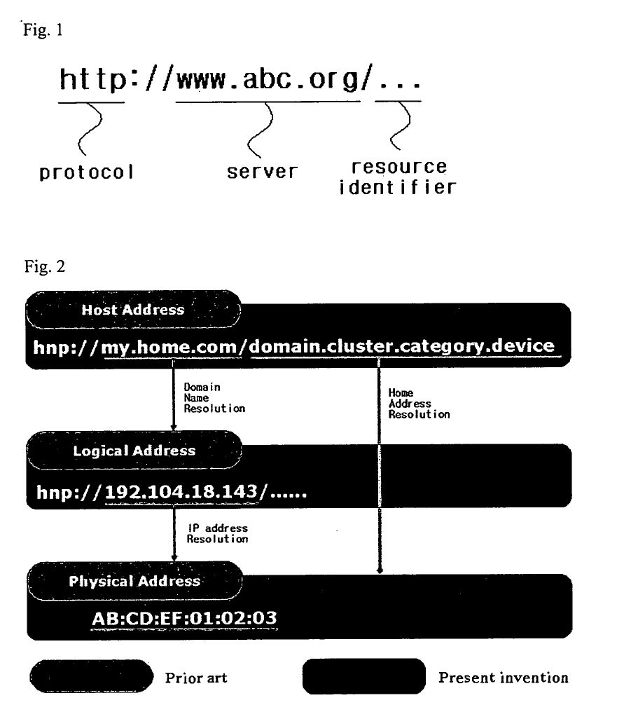

### DETAILED DESCRIPTION OF THE PREFERRED EMBODIMENT

The present invention is directed to a human readable and writable addressing method in a home network that obviates one or more problems due to limitations and disadvantages of the related art.

An object of the present invention is to provide an addressing method in a home network which is easily readable and writable to users, and compatible regardless of network types.

To achieve this object and other advantages and in accordance with the purpose of the invention, as embodied and broadly described herein, the present invention provides a human readable and writable addressing method in a home network comprising the steps of: inputting a URL type; inputting the address of a gateway server; and inputting a device indicator.

An example of a human readable and writable address in the home network in accordance with the present invention is “hnp://www.abc.bb.cc/domain.cluster.category.device”.

In the example, “hnp://” is one of the URL (Uniform Resource Locator) types and indicates that information or device can be accessed by using an HNP structure in accordance with the present invention. In addition, “http://” can be used instead of “hnp://”. “www.abc.bb.cc” identifies a home gateway server that has a unique IP address and functions as a first entrance to access the home network from the outside of the home network. In addition, the home gateway server stores the information about the physical addresses of each device in the home network and translates the information of each device indicators into the corresponding physical addresse upon a request.

“domain.cluster.category.device” is a device indicator. The device indicator comprises a domain address, a cluster address, a category address and a device address.

“domain” represents the domain address which informs the location of the device such as a living room, a kitchen, a dining room, and room #1.

“cluster” represents the cluster address which distinguishes the network types of each device in the home network. The devices in the home network may be connected to heterogeneous networks such as PLC, Bluetooth, Ethernet and Lontalk. For example, one TV may be connected to the Ethernet and another TV may be connected to the Lontalk. Thus, the cluster of the device indicator informs the network corresponding to each device.

“category” represents the category address which classifies the devices on the basis of their usage. For example, DVD players and audios may be included in “AV devices”.

“device” is the domain address which represents a unique device name with a reference number. For example, “TV”, “stove”, “security system”, and “DVD player” can be “device” of the devic indicator. If several same devices are in the same domain, cluster and category, the reference numbers to distinguish each other, such as “TV#1”, “TV#2” and “TV#3”, can be used. Accordingly, “hnp://203.253.130.1/livingroom.ethernet.avdevices.camcoder” represents that users can access a camcoder placed in a living room and connected to the Ethernet through the gateway sever having 203.253.130.1 from the outside of the house. Thus, users can easily read and write the hnp address without confusion.

FIG. 2 is a block-diagram comparing the prior method with the present invention.

Referring to FIG. 2, according to the prior art, a conventional host name is converted into a logical address through a domain name re-solver and the logical address is then converted into the physical address through an IP address analyzer. On the other hand, in the addressing method according to the present invention, because the home gateway server has the information about the relationship between the physical address of the device and the device indicator, the host name is directly converted into the physical address of the device.

Accordingly, the present invention can provide a human readable and writable address for the home network and, thereby, the device on the network can be readily identified. In addition, even under the condition where various devices are connected with heterogeneous networks, the new addressing method in accordance with the present invention can be compatible without problems.

It is noted that this patent claims priority from Korean Patent Application Number 10-2004-0046785, which was filed on Jun. 22, 2004, and is hereby incorporated by reference in its entirety.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

1. A human readable and writable addressing method in a home network comprising the steps of:
inputting a URL type;
inputting the address of a gateway server; and
inputting a device indicator;

2. A method as defined by claim 1, wherein the URL type is “hnp” or “http”.

3. A method as defined by claim 1, wherein the device indicator comprises a domain address, a cluster address, a category address and a device address.

4. A method as defined by claim 3, wherein the domain address represents the location of the device.

5. A method as defined by claim 3, wherein the cluster address distinguishes the network types.

6. A method as defined by claim 3, wherein the category address classifies the devices on the basis of their usage.

7. A method as defined by claim 3, wherein the device address represents a unique device name.
